(19) United States
(12) Patent Application Publication
(10) Pub. No.: US 2017/0187431 A1
(43) Pub. Date: Jun. 29, 2017

(54) Antenna multiplexing device and mobile terminal

(71) Applicants: LE HOLDINGS (BEIJING) CO., LTD., Beijing (CN); LEMOBILE INFORMATION TECHNOLOGY (BEIJING) CO., LTD., Beijing (CN)

(72) Inventor: Decai ZHU, Beijing (CN)

(21) Appl. No.: 15/241,575

(22) Filed: Aug. 19, 2016

Related U.S. Application Data
(63) Continuation of application No. PCT/CN2016/088700, filed on Jul. 5, 2016.

(30) Foreign Application Priority Data
Dec. 29, 2015 (CN) 2015110176743

(51) Int. Cl. H04B 7/04; H04W 88/06; H04W 84/12; H04B 1/3827; H04W 84/04

(52) U.S. Cl. CPC H04B 7/0413; H04B 1/3833; H04W 84/042; H04W 84/12; H04W 88/06

(57) ABSTRACT

Disclosed are an antenna multiplexing device and a mobile terminal. The antenna multiplexing device comprises a cellular primary antenna, a cellular diversity antenna, a WLAN antenna, a first radio frequency switch, a second radio frequency switch, a first communication module, a second communication module and a gating module; an end of the first radio frequency switch is connected with the first communication module; an end of the second radio frequency switch is connected with the first communication module and the second communication module respectively; the second communication module comprises a multiplexing port and an antenna connection port, and the second communication module is connected with the second radio frequency switch via the multiplexing port and connected with the WLAN antenna via the antenna connection port.

### CROSS REFERENCE TO RELATED APPLICATIONS

The present application is a continuation of PCT application which has an application number of PCT/CN2016/088700 and was filed on Jul. 5, 2016. This application is based upon and claims priority to Chinese Patent Application NO. 201511017674.3, titled “antenna multiplexing device and mobile terminal”, filed on Dec. 29, 2015 with the Chinese Patent Office, the entire contents of which are incorporated herein by reference.

### TECHNICAL FIELD

The disclosure relates to the technical field of antenna multiplexing, and more specifically to an antenna multiplexing device and a mobile terminal.

### BACKGROUND

As wireless communication develops, usually a wireless communication terminal (e.g., a mobile phone) has only one antenna for implementing voice communication, and also at least needs a WLAN antenna for performing WLAN (Wireless Local Area Networks) function (e.g., Bluetooth function or WLAN function). The position of this WLAN antenna is different from the position of the antenna for implementing the voice communication. When a user of a wireless communication terminal is in a certain region, there exist certain changes of intensity of the antenna signal due to position and direction issues. At this time, there will be different signal intensities in different directions.

At present, mainstream wireless communication terminals universally all provide WLAN MIMO (Multiple-Input Multiple-Output) technology and cellular technology. To improve throughput, hardware platforms all provide a dual-antenna scheme. Regarding cellular technology, a diversity antenna has already covered various 2.4G/3G/4G standard, provides a diversity reception gain on the one hand and provides ASDIV (Antenna Switch Diversity) to implement antenna handover on the other hand to cope with a scenario that antenna performance deteriorates abruptly due to the user's operations such as holding the wireless communication terminal with hand. Regarding WLAN MIMO technology, the second antenna is introduced to bring about a lot of benefits.

A wireless communication terminal product is a highly-integrated electronic product. Demands for the number of antennas and frequency coverage greatly increase the difficulty in antenna research and development. Antenna mutual backup and multiplexing technologies are introduced constantly.

In the relevant prior art, a cellular diversity antenna is used for an antenna in WLAN (e.g., a total of three manners, namely, 2.4G only, 5G only, 2.4G&5G) MIMO. That is, WLAN MIMO multiplexes the cellular diversity antenna. As such, action of the cellular diversity antenna may be maximized so that there is no need to additionally provide an individual antenna for WLAN MIMO.

However, this scheme does not take into account relevancy issue of WLAN MIMO antenna and cellular diversity antenna. In the mainstream layout scheme, the WLAN antenna is very close to the cellular diversity antenna with generally a very low isolation degree so that two antennas constituting the MIMO have a very high relevancy and do not satisfy requirements of MIMO for the antennas.

### SUMMARY

An object of the present application is to provide an antenna multiplexing device by which a WLAN antenna multiplexes a cellular primary antenna, and a mobile terminal.

According to an aspect of the present application, there is provided an antenna multiplexing device, comprising a cellular primary antenna, a cellular diversity antenna, a WLAN antenna, a first radio frequency switch, a second radio frequency switch, a first communication module, a second communication module and a gating module; an end of the first radio frequency switch is connected with the first communication module; an end of the second radio frequency switch is connected with the first communication module and the second communication module respectively; the second communication module comprises a multiplexing port and an antenna connection port, the second communication module is connected with the second radio frequency switch via the multiplexing port and connected with the WLAN antenna via the antenna connection port; wherein the gating module is connected with the cellular primary antenna, the cellular diversity antenna, the first radio frequency switch and the second radio frequency switch respectively, the gating module is configured to enable the cellular primary antenna to communicate with the second radio frequency switch in a first working mode, and enable the cellular diversity antenna to communicate with the second radio frequency switch in a second working mode.

According to another aspect of the present application, there is provided a mobile terminal, comprising an antenna multiplexing device, the antenna multiplexing device comprising a cellular primary antenna, a cellular diversity antenna, a WLAN antenna, a first radio frequency switch, a second radio frequency switch, a first communication module, a second communication module and a gating module; an end of the first radio frequency switch is connected with the first communication module; an end of the second radio frequency switch is connected with the first communication module and the second communication module respectively; the second communication module comprises a multiplexing port and an antenna connection port, the second communication module is connected with the second radio frequency switch via the multiplexing port and connected with the WLAN antenna via the antenna connection port; wherein the gating module is connected with the cellular primary antenna, the cellular diversity antenna, the first radio frequency switch and the second radio frequency switch respectively, the gating module is configured to enable the cellular primary antenna to communicate with the second radio frequency switch in a first working mode, and enable the cellular diversity antenna to communicate with the second radio frequency switch in a second working mode.

In the antenna multiplexing device and the mobile terminal according to the present disclosure, the gating module is configured to enable the cellular primary antenna and the WLAN antenna to form the MIMO antenna scheme in the first working mode, reduce the relevancy of the MIMO antenna under multiple frequency bands and improve antenna efficiency, and meanwhile the two double-pole double-throw switches employed by the gating module may reduce direct path loss of a main path and a diversity path.

### BRIEF DESCRIPTION OF THE DRAWINGS

One or more embodiments is/are accompanied by the following figures for illustrative purposes and serve to only to provide examples. These illustrative descriptions in no way limit any embodiments. Similar elements in the figures are denoted by identical reference numbers. Unless it states the otherwise, it should be understood that the drawings are not necessarily proportional or to scale.

FIG. 1 illustrates a block diagram of an antenna multiplexing device according to a first embodiment of the present application;

FIG. 2 illustrates a block diagram of an antenna multiplexing device according to a second embodiment of the present application;

FIG. 3 illustrates a block diagram of an antenna multiplexing device according to a third embodiment of the present application.

### DETAILED DESCRIPTION

Exemplary embodiments of the present disclosure will be described in more detail below with reference to figures. Although the figures show exemplary embodiments of the present disclosure, it should be appreciated that the present disclosure may be implemented in various forms and should not be limited by embodiments illustrated here. On the contrary, these embodiments are provided to enable more thorough understanding of the present disclosure, and completely convey the scope of the present disclosure to those skilled in the art.

FIG. 1 illustrates a block diagram of an antenna multiplexing device according to a first embodiment of the present application. The antenna multiplexing device 100 comprises a cellular primary antenna 11, a cellular diversity antenna 12, a WLAN antenna 13, a first radio frequency switch 14, a second radio frequency switch 15, a first communication module 16, a second communication module 17 and a gating module 18.

Wherein the first radio frequency switch 14 is connected with the first communication module 16; the second radio frequency switch 15 is connected with the first communication module 16 and the second communication module 17 respectively; the second communication module 17 comprises a multiplexing port 171 and an antenna connection port 172, is connected with the second radio frequency switch 15 via the multiplexing port 171 and connected with the WLAN antenna 13 via the antenna connection port 172; wherein the gating module 18 is connected with the cellular primary antenna 11, the cellular diversity antenna 12, the first radio frequency switch 14 and the second radio frequency switch 15 respectively, and used to enable the cellular primary antenna 11 to communicate with the second radio frequency switch 15 in a first working mode; and enable the cellular diversity antenna 12 to communicate with the second radio frequency switch 15 in a second working mode.

In the present embodiment, the first communication module 16 may be a mobile communication module of an electronic apparatus and may implement communication at multiple frequency bands. The second communication module 17 may be a WLAN communication module of an electronic apparatus and may implement communication at multiple frequency bands. In the first working mode, namely, when the WLAN communication module works, the second radio frequency switch 15 is configured to enable the cellular primary antenna 11 to communicate with the second communication module 17 in the first working mode so that the WLAN antenna and cellular primary antenna form a MIMO antenna to improve the Internet access rate. In the second working mode, namely, when the mobile communication module works, the first radio frequency switch 14 and the second radio frequency switch 15 enable the cellular primary antenna and the cellular diversity antenna to communicate with the first communication module 16 to implement mobile communication.

The second communication module 17 comprises a radio frequency module 173, a first radio frequency front-end module 174, a second radio frequency front-end module 175 and a first duplexer 176.

In the present embodiment, the radio frequency module 173 comprises a first frequency band antenna connection port 1731 and a second frequency band antenna connection port 1732, wherein the first frequency band antenna connection port 1731 is configured to transmit and receive a radio frequency signal at 2.4G frequency band, and the second frequency band antenna connection port 1732 is configured to transmit and receive a radio frequency signal at 5G frequency band.

The first radio frequency front-end module 174 is connected with the first frequency band antenna connection port 1731 of the radio frequency module 173; the second radio frequency front-end module 175 is connected with the second frequency band antenna connection port 1732 of the radio frequency module 173; the first duplexer 176 is connected with the first radio frequency front-end module 174 and the second radio frequency front-end module 175 respectively and configured to combine a first frequency band signal and a second frequency band signal of the radio frequency module 173 and transmit the combined signal via the WLAN antenna 13, and decompose a signal received via the WLAN antenna 13 into the first frequency band signal and the second frequency band signal and transmit the decomposed signal to the radio frequency module 173 via the first radio frequency front-end module 174 and the second radio frequency front-end module 175 respectively.

In the present embodiment, the radio frequency module 173 further comprises a first frequency band multiplexing port 1733. The first frequency band multiplexing port 1733 is configured to transmit and receive a radio frequency signal at 2.4G frequency band.

The second communication module 17 further comprises a third radio frequency front-end module 177 connected with the radio frequency module 173 via the first frequency band multiplexing port 1733.

In the present embodiment, the gating module 18 comprises two double-pole double-throw switches. The WLAN antenna 13 is a WiFi antenna, and the radio frequency module 173 is a WiFi radio frequency module.

In the present embodiment, this technical solution is only with respect to a diversity antenna of WiFi 2.4G MIMO, and the WiFi antenna may be switched to the cellular primary antenna via the gating module 18.

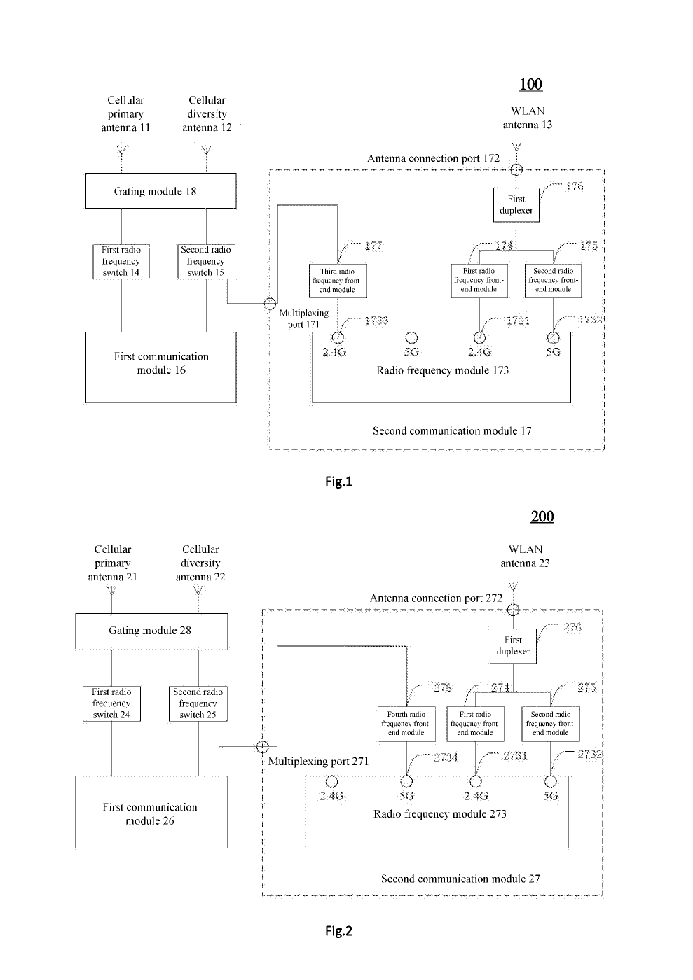

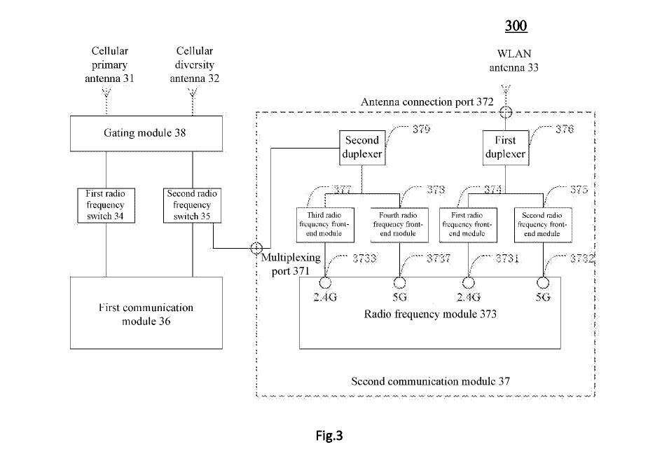

In the antenna multiplexing device and the mobile terminal according to the present disclosure, the gating module is configured to enable the cellular primary antenna and the WLAN antenna to form the MIMO antenna scheme in the first working mode, reduce the relevancy of the MIMO antenna under the first frequency band and improve antenna efficiency, and meanwhile the two double-pole double-throw switches employed by the gating module may reduce direct path loss of a main path and a diversity path. FIG. 2 illustrates a block diagram of an antenna multiplexing device according to a second embodiment of the present application. As shown in FIG. 2, the antenna multiplexing device 200 comprises a cellular primary antenna 21, a cellular diversity antenna 22, a WLAN antenna 23, a first radio frequency switch 24, a second radio frequency switch 25, a first communication module 26, a second communication module 27 and a gating module 28.

Wherein the first radio frequency switch 24 is connected with the first communication module 26; the second radio frequency switch 25 is connected with the first communication module 26 and the second communication module 27 respectively; the second communication module 27 comprises a multiplexing port 271 and an antenna connection port 272, is connected with the second radio frequency switch 25 via the multiplexing port 271 and connected with the WLAN antenna 23 via the antenna connection port 272; wherein the gating module 28 is connected with the cellular primary antenna 21, the cellular diversity antenna 22, the first radio frequency switch 24 and the second radio frequency switch 25 respectively, and configured to enable the cellular primary antenna 21 to communicate with the second radio frequency switch 25 in a first working mode; and enable the cellular diversity antenna 22 to communicate with the second radio frequency switch 25 in a second working mode.

In the present embodiment, the first communication module 26 may be a mobile communication module of an electronic apparatus and may implement communication at multiple frequency bands. The second communication module 27 may be a WLAN communication module of an electronic apparatus and may implement communication at multiple frequency bands. In the first working mode, namely, when the WLAN communication module works, the second radio frequency switch 25 is configured to enable the cellular primary antenna 21 to communicate with the second communication module 27 in the first working mode so that the WLAN antenna and cellular primary antenna form a MIMO antenna to improve the Internet access rate. In the second working mode, namely, when the mobile communication module works, the first radio frequency switch 24 and the second radio frequency switch 25 enable the cellular primary antenna and the cellular diversity antenna to communicate with the first communication module 26 to implement mobile communication.

The second communication module 27 comprises a radio frequency module 273, a first radio frequency front-end module 274, a second radio frequency front-end module 275 and a first duplexer 276.

In the present embodiment, the radio frequency module 273 comprises a first frequency band antenna connection port 2731 and a second frequency band antenna connection port 2732, wherein the first frequency band antenna connection port 2731 is configured to transmit and receive a radio frequency signal at 2.4G frequency band, and the second frequency band antenna connection port 2732 is configured to transmit and receive a radio frequency signal at 5G frequency band.

The first radio frequency front-end module 274 is connected with the first frequency band antenna connection port 2731 of the radio frequency module 273; the second radio frequency front-end module 275 is connected with the second frequency band antenna connection port 2732 of the radio frequency module 273; the first duplexer 276 is connected with the first radio frequency front-end module 274 and the second radio frequency front-end module 275 respectively and configured to combine a first frequency band signal and a second frequency band signal of the radio frequency module 273 and transmit the combined signal via the WLAN antenna 23, and decompose a signal received via the WLAN antenna 23 into the first frequency band signal and the second frequency band signal and transmit the decomposed signal to the radio frequency module 273 via the first radio frequency front-end module 274 and the second radio frequency front-end module 275 respectively.

In the present embodiment, the radio frequency module 273 further comprises a second frequency band multiplexing port 2734. The second frequency band multiplexing port 2734 is configured to transmit and receive a radio frequency signal at 5G frequency band.

The second communication module 27 further comprises a fourth radio frequency front-end module 278 connected with the radio frequency module 273 via the second frequency band multiplexing port 2734.

In the present embodiment, the gating module 28 comprises two double-pole double-throw switches. The WLAN antenna 23 is a WiFi antenna, and the radio frequency module 273 is a WiFi radio frequency module.

In the present embodiment, this technical solution is only with respect to a diversity antenna of WiFi 5G MIMO, and the WiFi antenna may be switched to the cellular primary antenna via the gating module 28.

In the antenna multiplexing device and the mobile terminal according to the present disclosure, the gating module is configured to enable the cellular primary antenna and the WLAN antenna to form the MIMO antenna scheme in the first working mode, reduce the relevancy of the MIMO antenna under the second frequency band and improve antenna efficiency, and meanwhile the two double-pole double-throw switches employed by the gating module may reduce direct path loss of a main path and a diversity path.

FIG. 3 illustrates a block diagram of an antenna multiplexing device according to a third embodiment of the present application. As shown in FIG. 3, the antenna multiplexing device 300 comprises a cellular primary antenna 31, a cellular diversity antenna 32, a WLAN antenna 33, a first radio frequency switch 34, a second radio frequency switch 35, a first communication module 36, a second communication module 37 and a gating module 38.

Wherein the first radio frequency switch 34 is connected with the first communication module 36; the second radio frequency switch 35 is connected with the first communication module 36 and the second communication module 37 respectively; the second communication module 37 comprises a multiplexing port 371 and an antenna connection port 372, is connected with the second radio frequency switch 35 via the multiplexing port 371 and connected with the WLAN antenna 33 via the antenna connection port 372; wherein the gating module 38 is connected with the cellular primary antenna 31, the cellular diversity antenna 32, the first radio frequency switch 34 and the second radio frequency switch 35 respectively, and configured to enable the cellular primary antenna 31 to communicate with the second radio frequency switch 35 in a first working mode; and enable the cellular diversity antenna 32 to communicate with the second radio frequency switch 35 in a second working mode.

In the present embodiment, the first communication module 36 may be a mobile communication module of an electronic apparatus and may implement communication at multiple frequency bands. The second communication module 37 may be a WLAN communication module of an electronic apparatus and may implement communication at multiple frequency bands. In the first working mode, namely, when the WLAN communication module works, the second radio frequency switch 35 is configured to enable the cellular primary antenna 31 to communicate with the second communication module 37 in the first working mode so that the WLAN antenna and cellular primary antenna form a MIMO antenna to improve the Internet access rate. In the second working mode, namely, when the mobile communication module works, the first radio frequency switch 34 and the second radio frequency switch 35 enable the cellular primary antenna and the cellular diversity antenna to communicate with the first communication module 36 to implement mobile communication.

The second communication module 37 comprises a radio frequency module 373, a first radio frequency front-end module 374, a second radio frequency front-end module 375 and a first duplexer 376.

In the present embodiment, the radio frequency module 373 comprises a first frequency band antenna connection port 3731 and a second frequency band antenna connection port 3732, wherein the first frequency band antenna connection port 3731 is configured to transmit and receive a radio frequency signal at 2.4G frequency band, and the second frequency band antenna connection port 3732 is configured to transmit and receive a radio frequency signal at 5G frequency band.

The first radio frequency front-end module 374 is connected with the first frequency band antenna connection port 3731 of the radio frequency module 373; the second radio frequency front-end module 375 is connected with the second frequency band antenna connection port 3732 of the radio frequency module 273; the first duplexer 376 is connected with the first radio frequency front-end module 374 and the second radio frequency front-end module 375 respectively and configured to combine a first frequency band signal and a second frequency band signal of the radio frequency module 373 and transmit the combined signal via the WLAN antenna 33, and decompose a signal received via the WLAN antenna 33 into the first frequency band signal and the second frequency band signal and transmit the decomposed signal to the radio frequency module 373 via the first radio frequency front-end module 374 and the second radio frequency front-end module 375 respectively.

In the present embodiment, the radio frequency module 373 further comprises a first frequency band multiplexing port 3733 and a second frequency band multiplexing port 3734. The first frequency band multiplexing port 3733 is configured to transmit and receive a radio frequency signal at 2.4G frequency band, and the second frequency band multiplexing port 3734 is configured to transmit and receive a radio frequency signal at 5G frequency band.

The second communication module 37 further comprises a third radio frequency front-end module 377, a fourth radio frequency front-end module 378 and a second duplexer 379, wherein the third radio frequency front-end module 377 is connected with the radio frequency module 373 via the first frequency band multiplexing port 3733; the fourth radio frequency front-end module 378 is connected with the radio frequency module 373 via the second frequency band multiplexing port 3734; the second duplexer 379 is connected with the third radio frequency front-end module 377 and the fourth radio frequency front-end module 378 respectively, and configured to combine a first frequency band signal and a second frequency band signal of the radio frequency module 373 and transmit the combined signal to the cellular primary antenna 31 via the gating module 38, and decompose a signal received via the cellular primary antenna 31 into the first frequency band signal and the second frequency band signal and transmit the decomposed signal to the radio frequency module 373 via the third radio frequency front-end module 377 and the fourth radio frequency front-end module 378 respectively.

In the present embodiment, the gating module 38 comprises two double-pole double-throw switches. The WLAN antenna 33 is a WiFi antenna, and the radio frequency module 373 is a WiFi radio frequency module.

In the present embodiment, this technical solution is only with respect to a diversity antenna of WiFi 2.4G MIMO and a diversity antenna of WiFi 5G MIMO, and the WiFi antenna may be switched to the cellular primary antenna via the gating module 38.

In the antenna multiplexing device and the mobile terminal according to the present disclosure, the gating module is used to enable the cellular primary antenna and the WLAN antenna to form the MIMO antenna scheme in the first working mode, reduce the relevancy of the MIMO antenna under the first frequency band and the second frequency band and improve antenna efficiency, and meanwhile the two double-pole double-throw switches employed by the gating module may reduce direct path loss of a main path and a diversity path.

Embodiments according to the present application are described above and these embodiments do not exhaust all details, do not limit the present disclosure and are only specific embodiments as stated. Obviously, many modifications and variations may be made according to the above depictions. In the description, these embodiments are selected and described in detail to better illustrate principles and actual application of the present application so that those skilled in the art can use the present application very well and modify use on the basis of the present application. The present application is only limited by the claim set and all scope and equivalents thereof.

1-20. (canceled)

21. An antenna multiplexing device, comprising a cellular primary antenna, a cellular diversity antenna, a WLAN antenna, a first radio frequency switch, a second radio frequency switch, a first communication module, a second communication module and a gating module;
an end of the first radio frequency switch is connected with the first communication module;
an end of the second radio frequency switch is connected with the first communication module and the second communication module respectively;
the second communication module comprises a multiplexing port and an antenna connection port, the second communication module is connected with the second radio frequency switch via the multiplexing port and connected with the WLAN antenna via the antenna connection port;
wherein the gating module is connected with the cellular primary antenna, the cellular diversity antenna, the first radio frequency switch and the second radio frequency switch respectively, and the gating module is configured to enable the cellular primary antenna to communicate with the second radio frequency switch in a first working mode, and enable the cellular diversity antenna to communicate with the second radio frequency switch in a second working mode.

22. The antenna multiplexing device according to claim 21, wherein the second radio frequency switch is configured to enable the cellular primary antenna to communicate with the second communication module in the first working mode.

23. The antenna multiplexing device according to claim 21, wherein the second communication module comprises a radio frequency module, a first radio frequency front-end module, a second radio frequency front-end module and a first duplexer;
wherein the radio frequency module comprises a first frequency band antenna connection port and a second frequency band antenna connection port;
the first radio frequency front-end module is connected with the first frequency band antenna connection port of the radio frequency module;
the second radio frequency front-end module is connected with the second frequency band antenna connection port of the radio frequency module;
an end of the first duplexer is connected with the first radio frequency front-end module and the second radio frequency front-end module respectively, the first duplexer is configured to combine a first frequency band signal and a second frequency band signal of the radio frequency module and transmit the combined signal via the WLAN antenna, and decompose a signal received via the WLAN antenna into the first frequency band signal and the second frequency band signal and transmit the decomposed signal to the radio frequency module via the first radio frequency front-end module and the second radio frequency front-end module respectively.

24. The antenna multiplexing device according to claim 23, wherein the radio frequency module further comprises at least one of a first frequency band multiplexing port or a second frequency band multiplexing port.

25. The antenna multiplexing device according to claim 24, wherein the second communication module further comprises a third radio frequency front-end module connected with the radio frequency module via the first frequency band multiplexing port.

26. The antenna multiplexing device according to claim 24, wherein the second communication module further comprises a fourth radio frequency front-end module connected with the radio frequency module via the second frequency band multiplexing port.

27. The antenna multiplexing device according to claim 24, wherein the second communication module further comprises a third radio frequency front-end module, a fourth radio frequency front-end module and a second duplexer; wherein the third radio frequency front-end module is connected with the radio frequency module via the first frequency band multiplexing port;
the fourth radio frequency front-end module is connected with the radio frequency module via the second frequency band multiplexing port;
an end of the second duplexer is connected with the third radio frequency front-end module and the fourth radio frequency front-end module respectively, and the second duplexer is configured to combine a first frequency band signal and a second frequency band signal of the radio frequency module and transmit the combined signal to the cellular primary antenna via the gating module, and decompose a signal received via the cellular primary antenna into the first frequency band signal and the second frequency band signal and transmit the decomposed signal to the radio frequency module via the third radio frequency front-end module and the fourth radio frequency front-end module respectively.

28. The antenna multiplexing device according to claims 21, wherein the WLAN antenna is a WiFi antenna.

29. The antenna multiplexing device according to claims 23, wherein the WLAN antenna is a WiFi antenna.

30. The antenna multiplexing device according to claim 28, wherein the radio frequency module is a WiFi radio frequency module.

31. A mobile terminal, comprising an antenna multiplexing device, the antenna multiplexing device comprising a cellular primary antenna, a cellular diversity antenna, a WLAN antenna, a first radio frequency switch, a second radio frequency switch, a first communication module, a second communication module and a gating module;
an end of the first radio frequency switch is connected with the first communication module;
an end of the second radio frequency switch is connected with the first communication module and the second communication module respectively;
the second communication module comprises a multiplexing port and an antenna connection port, and the second communication module is connected with the second radio frequency switch via the multiplexing port and connected with the WLAN antenna via the antenna connection port;
wherein the gating module is connected with the cellular primary antenna, the cellular diversity antenna, the first radio frequency switch and the second radio frequency switch respectively, the gating module is configured to enable the cellular primary antenna to communicate with the second radio frequency switch in a first working mode, and enable the cellular diversity antenna to communicate with the second radio frequency switch in a second working mode.

32. The mobile terminal according to claim 31, wherein the second radio frequency switch is configured to enable the cellular primary antenna to communicate with the second communication module in the first working mode.

33. The mobile terminal according to claim 31, wherein the second communication module comprises a radio frequency module, a first radio frequency front-end module, a second radio frequency front-end module and a first duplexer;
wherein the radio frequency module comprises a first frequency band antenna connection port and a second frequency band antenna connection port;
the first radio frequency front-end module is connected with the first frequency band antenna connection port of the radio frequency module;
the second radio frequency front-end module is connected with the second frequency band antenna connection port of the radio frequency module;
an end of the first duplexer is connected with the first radio frequency front-end module and the second radio frequency front-end module respectively, the first duplexer is configured to combine a first frequency band signal and a second frequency band signal of the radio frequency module and transmit the combined signal via the WLAN antenna, and decompose a signal received via the WLAN antenna into the first frequency band signal and the second frequency band signal and transmit the decomposed signal to the radio frequency module via the first radio frequency front-end module and the second radio frequency front-end module respectively.

34. The mobile terminal according to claim 33, wherein the radio frequency module further comprises at least one of a first frequency band multiplexing port or a second frequency band multiplexing port.

35. The mobile terminal according to claim 34, wherein the second communication module further comprises a third radio frequency front-end module connected with the radio frequency module via the first frequency band multiplexing port.

36. The mobile terminal according to claim 34, wherein the second communication module further comprises a fourth radio frequency front-end module connected with the radio frequency module via the second frequency band multiplexing port.

37. The mobile terminal according to claim 34, wherein the second communication module further comprises a third radio frequency front-end module, a fourth radio frequency front-end module and a second duplexer; wherein the third radio frequency front-end module is connected with the radio frequency module via the first frequency band multiplexing port;
the fourth radio frequency front-end module is connected with the radio frequency module via the second frequency band multiplexing port;
an end of the second duplexer is connected with the third radio frequency front-end module and the fourth radio frequency front-end module respectively, and the second duplexer is configured to combine a first frequency band signal and a second frequency band signal of the radio frequency module and transmit the combined signal to the cellular primary antenna via the gating module, and decompose a signal received via the cellular primary antenna into the first frequency band signal and the second frequency band signal and transmit the decomposed signal to the radio frequency module via the third radio frequency front-end module and the fourth radio frequency front-end module respectively.

38. The mobile terminal according to claims 31, wherein the WLAN antenna is a WiFi antenna.

39. The mobile terminal according to claims 33, wherein the WLAN antenna is a WiFi antenna.

40. The mobile terminal according to claim 38, wherein the radio frequency module is a WiFi radio frequency module.
